(19) United States
(12) Patent Application Publication
(10) Pub. No.: US 2026/0205740 A1
(43) Pub. Date: Jul. 16, 2026

(54) Driving Circuit and Air-Pulse Generating System with Asymmetric Initial Deflection

(71) Applicant: xMEMS Labs, Inc., Santa Clara, CA (US)

(72) Inventors: Jing-Meng Liu, San Jose, CA (US); Ming-Hung Chang, Hsinchu County (TW); Eldwin Jiaqiang Ng, Sunnyvale, CA (US); Kai-Chieh Chang, Hsinchu City (TW)

(73) Assignee: xMEMS Labs, Inc., Santa Clara, CA (US)

(21) Appl. No.: 19/446,931

(22) Filed: Jan. 12, 2026

Related U.S. Application Data
(60) Provisional application No. 63/744,882, filed on Jan. 14, 2025.
(60) Provisional application No. 63/748,420, filed on Jan. 22, 2025.
(60) Provisional application No. 63/799,360, filed on May 3, 2025.
(60) Provisional application No. 63/803,953, filed on May 12, 2025.
(60) Provisional application No. 63/885,344, filed on Sep. 21, 2025.
(60) Provisional application No. 63/894,606, filed on Oct. 6, 2025.

(51) Int. Cl. H04R 17/10; H04R 3/04

(52) U.S. Cl. CPC H04R 17/10; H04R 3/04

(57) ABSTRACT

A driving circuit includes a valve driving signal generator, configured to generate a first valve driving signal and a second valve driving signal. The driving circuit is configured to drive an air-pulse generating device. The air-pulse generating device includes a flap pair. The flap pair includes a first flap and a second flap. The flap pair is driven by the valve driving signal generator to possess an initial deflection difference or exhibits an average displacement difference between the first flap and the second flap.

### CROSS REFERENCE TO RELATED APPLICATIONS

This application claims the benefit of U.S. Provisional Application No. 63/744,882, filed on Jan. 14, 2025. Further, this application claims the benefit of U.S. Provisional Application No. 63/748,420, filed on Jan. 22, 2025. The contents of these applications are incorporated herein by reference.

### BACKGROUND OF THE INVENTION

### 1. Field of the Invention

The present application relates to a driving circuit and an air-pulse generating system with asymmetric initial deflection.

### 2. Description of the Prior Art

Unless otherwise indicated herein, the approaches described in this section are not prior art to the claims in this application and are not admitted as prior art by inclusion in this section.

Conventionally, speaker driver and back enclosure are two major design challenges in the speaker industry. It is difficult for one single conventional speaker (such as dynamic driver) to cover an entire audio frequency band, e.g., from 20 Hz to 20 KHz. To produce high fidelity sound with high enough sound pressure level (SPL), both the radiating/moving surface and volume/size of back enclosure for the conventional speaker are required to be sufficiently large.

U.S. Pat. Nos. 9,736,595 and 10,367,430 have discussed ultrasonic pulse for sound producing application has been discussed. Moreover, Applicant discloses APG (APG: air-pulse generating) device or APPS (APPS: air pressure pulse speaker), in U.S. Pat. Nos. 10,425,732, 11,172,310, 10,425,732, 11,043,197 and 11,445,279, to resolve the above bandwidth and size issues.

However, previously proposed APG devices have not fully utilize structural/device resonance gain, such that acoustic performance (such as SPL) is limited and it consumes more power.

Therefore, it is necessary to improve the prior art.

### SUMMARY OF THE INVENTION

It is therefore a primary objective of the present application to provide a driving circuit and an air-pulse generating system with asymmetric initial deflection, to improve over disadvantages of the prior art.

An embodiment of the present application discloses an air-pulse generating system, comprising a driving circuit and an air-pulse generating device comprising a film structure; wherein the film structure comprises a flap pair, and the flap pair comprises a first flap and a second flap opposite to each other; wherein the flap pair is driven by the driving circuit to operate at an ultrasonic frequency, such that the air-pulse generating device produces a plurality of air pulses at an ultrasonic pulse rate; wherein the flap pair possesses an initial deflection difference or exhibits an average displacement difference between the first flap and the second flap.

An embodiment of the present application discloses an air-pulse generating system, comprising a driving circuit and an air-pulse generating device comprising a film structure; wherein the film structure comprises a flap pair, and the flap pair comprises a first flap and a second flap opposite to each other; wherein the flap pair is driven by the driving circuit to operate at an ultrasonic frequency, such that the air-pulse generating device produces a plurality of air pulses at an ultrasonic pulse rate; wherein the flap pair is driven by the driving circuit to perform a differential mode movement to form a virtual valve; wherein the virtual valve is closed during a time corresponding to a first reversal of a first flap movement of the first flap and a second reversal of a second flap movement of the second flap.

An embodiment of the present application discloses an air-pulse generating system, comprising a driving circuit and an air-pulse generating device comprising a film structure; wherein the film structure comprises a flap pair, and the flap pair comprises a first flap and a second flap opposite to each other; wherein the flap pair is driven by the driving circuit to operate at an ultrasonic frequency, such that the air-pulse generating device produces a plurality of air pulses at an ultrasonic pulse rate; wherein the flap pair is driven by the driving circuit to perform a differential mode movement to form a virtual valve; wherein the flap pair is driven by the driving circuit to perform a common mode movement, to form an ultrasonic pressure variation; wherein a pressure variant frequency corresponds to the common mode movement and a valve driving frequency corresponds to the differential mode movement are the same.

An embodiment of the present application discloses a driving circuit, comprising a valve driving signal generator, configured to generate a first valve driving signal and a second valve driving signal; wherein the driving circuit is configured to drive an air-pulse generating device, the air-pulse generating device comprises a flap pair, and the flap pair comprises a first flap and a second flap; wherein the flap pair is driven by the valve driving signal generator to possess an initial deflection difference or exhibits an average displacement difference between the first flap and the second flap.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side-view schematic diagram of an air-pulse generating device according to an embodiment of the present application.

FIG. 2 is a schematic diagram of signal waveforms according to an embodiment of the present application.

FIG. 3 is a schematic diagram of snapshots of membrane/flap movement according to an embodiment of the present application.

FIG. 4 is a schematic diagram of a frequency response of flap/membrane displacement according to an embodiment of the present application.

FIG. 5 is a side-view schematic diagram of an air-pulse generating device according to an embodiment of the present application.

FIG. 6 illustrates the relationship between flap displacement and valve opening according to an embodiment of the present application.

FIG. 7 illustrates the relationship between flap displacement and valve opening according to an embodiment of the present application.

FIG. 8 is a schematic diagram of signal waveforms according to an embodiment of the present application.

FIG. 9 is a schematic diagram of snapshots of membrane/flap movement according to an embodiment of the present application.

FIG. 10 is a side-view schematic diagram of air-pulse generating devices according to embodiments of the present application.

FIG. 11 is a side-view schematic diagram of an air-pulse generating device according to an embodiment of the present application.

FIG. 12 is a side-view schematic diagram of an air-pulse generating device according to an embodiment of the present application.

FIG. 13 is a top-view schematic diagram of an air-pulse generating device according to an embodiment of the present application.

FIG. 14 is a schematic diagram of an air-pulse generating system according to an embodiment of the present application.

FIG. 15 is a schematic diagram of a valve driving signal generator according to an embodiment of the present application.

FIG. 16 is a timing diagram of a raw valve driving signal generator according to an embodiment of the present application.

FIG. 17 is a schematic diagram of a raw valve driving signal generator according to an embodiment of the present application.

FIG. 18 is a timing diagram of a raw valve driving signal generator according to an embodiment of the present application.

### DETAILED DESCRIPTION

Content of U.S. Pat. Nos. 11,943,585, 12,107,546, 12,261,567 and application Ser. No. 19/035,763 is incorporated herein by reference.

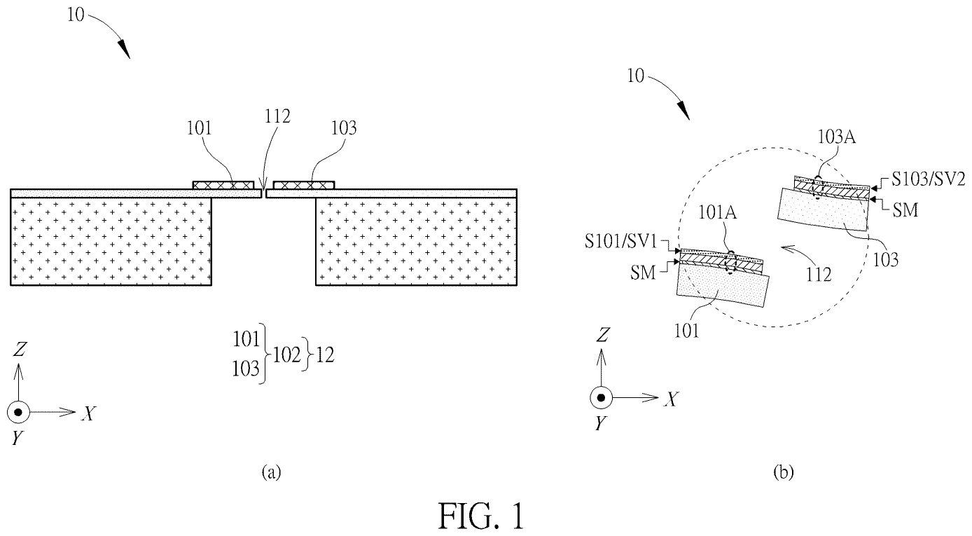

U.S. Pat. No. 11,943,585 filed by Applicant discloses an air-pulse generating (APG) device 10, which is shown in FIG. 1. The APG device 10 comprises a film structure 12 comprising a flap pair 102. The flap pair 102 comprises a first flap 101 and a second flap 103 opposite to each other. The APG device 10 also comprises an actuator 101A disposed on the flap 101 and an actuator 103A disposed on the flap 103. The actuators 101A and 103A are driven by valve (demodulation) driving signals S101/SV1 and S103/SV2, respectively. The actuators 101A and 103A are also driven by a pressure (modulation) driving signal SM. Driven by the signals S101/SV1, S103/SV2 and SM, the APG device 10 is able to produce a plurality of air pulses at an ultrasonic pulse rate. The actuator 101A/103A comprises a top electrode and a bottom electrode. The two electrodes receive the valve (demodulation) driving signal and the pressure (modulation) driving signal. In the embodiment shown in FIG. 1, the top electrode receives the valve (demodulation) driving signal (e.g., S101/SV1 or S103/SV2) and the bottom electrode receives the pressure (modulation) driving signal SM, but not limited thereto.

The pressure (modulation) driving signal SM drives the flap pair 102 to perform a common mode movement, to form an ultrasonic air pressure variation. The valve (demodulation) driving signals S101 and S103 drive the flap pair to perform a differential mode movement. Suppose U_{z,101} and U_{z,103} represent displacement (in Z/vertical direction) of the flaps 101 and 103, respectively. The common mode movement may refer to a movement component of the flap pair which is (U_{z,101}+U_{z,103})/2, and the differential mode movement may refer to a movement component of the flap pair which is |U_{z,101}−U_{z,103}|/2.

A slit 112 is formed between the flaps 101 and 103. When the flap pair performs the differential mode movement (sometimes abbreviated as differential movement) such that ΔU_{z}=|U_{z,101}−U_{z,103}| is greater than a thickness of the flap, an opening (also denoted as 112) is formed. From one perspective, the differential movement of flaps 101 and 103 forms a virtual valve, also denoted as 112. When ΔU_{z} is small (smaller than the thickness of the flap) and/or an acoustic impedance/resistance is large so that airflow through the virtual valve 112 is negligible, the virtual valve 112 can be viewed as functionally closed. In this state, the virtual valve 112 retains a configuration of the slit 112, as shown in FIG. 1(a). When ΔU_{z} is large (larger than the thickness of the flap) and/or an acoustic impedance/resistance is small so that airflow through the virtual valve 112 is significant, the virtual valve 112 can be viewed as functionally opened. In this state, the virtual valve 112 retains a configuration of the opening 112, as shown in FIG. 1(b).

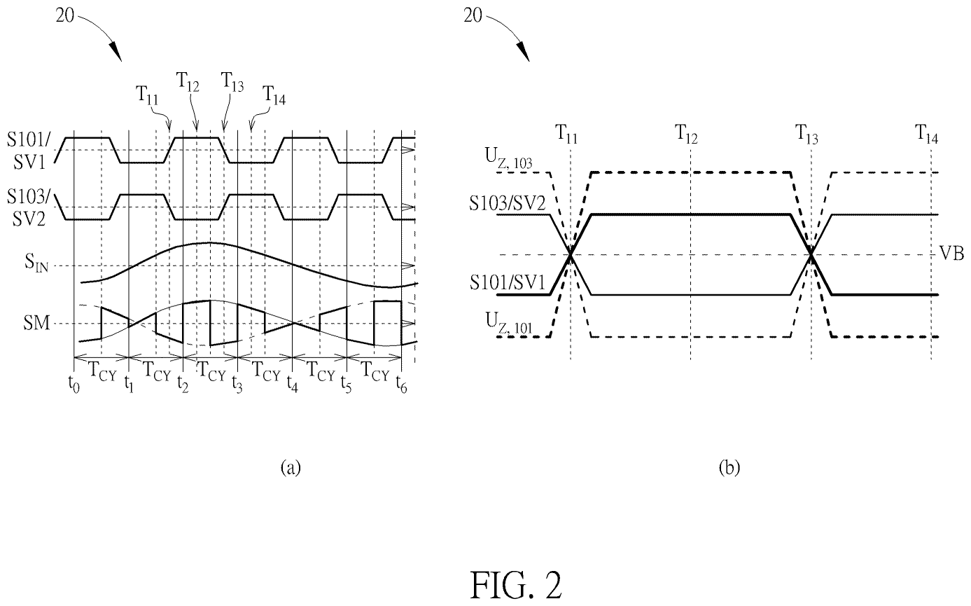

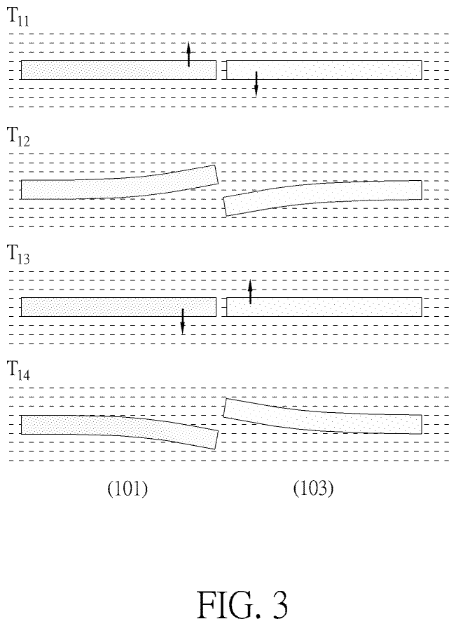

FIG. 2(a) illustrates a driving scheme 20 showing waveforms of the signals S101/SV1, S103/SV2 and SM over multiple cycles T_{CY}. FIG. 2(b) illustrates waveforms of the signals S101/SV1, S103/SV2 and corresponding displacement U_{z,101}/U_{z,103}. FIG. 3 illustrates snapshots of membrane/flap movement for the flaps 101 and 103 using the driving scheme 20.

The pressure (modulation) driving signal SM driving the flap pair to perform the common mode movement is to produce an (amplitude-modulated) ultrasonic air pressure variation with an ultrasonic carrier frequency. The actual waveform of the pressure (modulation) driving signal SM is similar to a double sideband with suppressed carrier (DSB-SC) modulated signal (or can be viewed as a generalized DSB-SC modulated signal), which can be referred to U.S. Pat. No. 12,107,546 filed by Applicant, which is not narrated herein for brevity.

In the present application, S101/S103 represents (valve) driving signal for the “flap 101/103”, and SV1/SV2 represents first/second “valve” driving signal. Both S101 and SV1 are used to denote driving signal applied on the flap 101 to perform the differential movement. Similarly, both S103 and SV2 are used to denote driving signal applied on the flap 101 to perform the differential movement. U_{z,101} and U_{z,103} are used to denote displacement of the flaps 101 and 103, respectively.

In FIG. 2 and FIG. 3, under the driving scheme 20, at T₁₁ and T₁₃, corresponding swinging transition times of flaps 101 and 103, the virtual valve 112 is closed; at T₁₂ and T₁₄, corresponding reversal times of flaps 101 and 103, the virtual valve 112 is opened.

Note that, in the driving scheme 20 shown in FIG. 2, the valve driving signals S101/SV1 and S103/SV2 are biased at the same level VB, and the flap pair may perform a differential movement with symmetric initial deflection. Initial deflection, from one (but not only one) perspective, may refer to a degree or an amount of flap deflection corresponding to the bias voltage (combining stress, when/for performing the differential movement). Since the valve driving signals S101/SV1 and S103/SV2 are biased at the same level VB, the initial deflection of the flap 101 and the initial deflection of the flap 103 should be the same, and in other words, symmetric, despite manufacturing process variations or impairments. From another perspective, initial deflection may also refer to neutral (stable) or average position when/for performing the differential movement.

From another perspective, the driving scheme 20 shown in FIG. 2, the flaps 101 and 103 may have same/symmetric average displacement. Average displacement of the flap 101 and average displacement of the flap 103 are (substantially) the same. There is no/barely average displacement difference between the flap 101 and 103. Herein average displacement may be taken over one or integer multiple of valve driving cycle(s) or over sufficient long period (e.g., 100 or more valve driving cycles), where the valve driving cycle, denoted as T_{CY,V}, may be T_{CY,V}=1/F_{V}, and F_{V} denotes valve driving frequency (will be detailed later).

However, given MEMS fabricated APG devices are high-Q devices (devices with high Q-factor), due to F_{V}=½·F_{M} (will be detailed later), mechanical resonant gain of the flap pair has not fully utilized (since only one of F_{V} or F_{M} enjoys resonance gain but the other does not, will be detailed later) and thus efficiency and effectiveness of the APG device are not optimized, when the flap pair is driven by the scheme 20.

Specifically, when the flap pair performs the differential movement with symmetric initial deflection (e.g., under the driving scheme 20), the valve driving frequency (denoted as F_{V}) corresponds to the differential mode movement would be a half of the pressure variant frequency (denoted as F_{M}) corresponds to the common mode movement, i.e., F_{V}=½·F_{M}, where the valve driving frequency F_{V} is a frequency of the valve driving signal and the pressure variant frequency F_{M} is the ultrasonic carrier frequency of the DSB-SC modulation. In this case, since F_{V}=½·F_{M}, only one of F_{V} and F_{M} can be placed closed to the structural resonant/resonance frequency Fr to benefit from the resonant gain. The other actuation signal may be limited to a lower gain.

In an embodiment, the pressure variant frequency F_{M} would also be the ultrasonic pulse rate Fₚᵤₗₛₑ of the APG device.

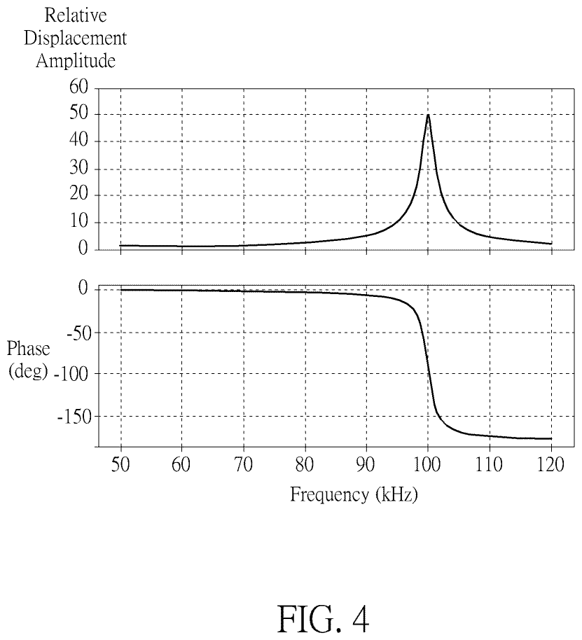

For example, FIG. 4 illustrates a frequency response of flap/membrane displacement. If the pressure variant frequency F_{M} is close to or at the resonant frequency, e.g., F_{M}≈Fr (Fr=100 kHz as shown in FIG. 4), the large gain (e.g., 10-50 times) is realized for generating the ultrasonic pressure variation. However, because of the virtual valve is driven at F_{V}=½·F_{M} (which is around 50 kHz in FIG. 4), way out of the resonance region. Consequently, the displacement gain for differential movement with symmetric initial deflection is quite limited, reaching a mere 1.3 times, which is inefficient.

Note that, the displacement of the differential movement determines a degree of opening of the virtual valve 112. As taught in U.S. Pat. No. 11,943,585 and application Ser. No. 19/287,761, the degree of opening of the virtual valve 112 determines demodulation conductance, which determines output performance such as sound pressure level (SPL), in sound producing application of the APG device.

Hence, limited displacement gain for differential movement with symmetric initial deflection would limit acoustic output performance such as SPL. Furthermore, to achieve a certain SPL, differential movement with symmetric initial deflection requires more/higher SV amplitude, amplitude of the valve driving signal (e.g., S101/SV1), and hence it would consume more power.

In addition, the differential movement with symmetric initial deflection would have false demodulation issue. It is because fabrication imperfections may result in an asymmetry between the opposing flaps 101 and 103. This may create a small demodulation carrier signal (acoustically) at F_{V} causing ultrasonic pulses around F_{M} to be demodulated not only around F_{V}, but also to the desired audible baseband. This may interfere with the quality of audio generation or may generate annoying audible tones for airflow devices if the demodulated acoustic signal falls within the audible range.

One remedy of such issues (e.g., driving inefficiency, false demodulation) is to impose Asymmetric initial deflection especially for the differential movement. In the following paragraphs, unless otherwise specified, discussion of flap displacement refers to (performing) differential movement, while common mode movement is ignored or assumed to be zero just for simplifying discussion of initial deflection.

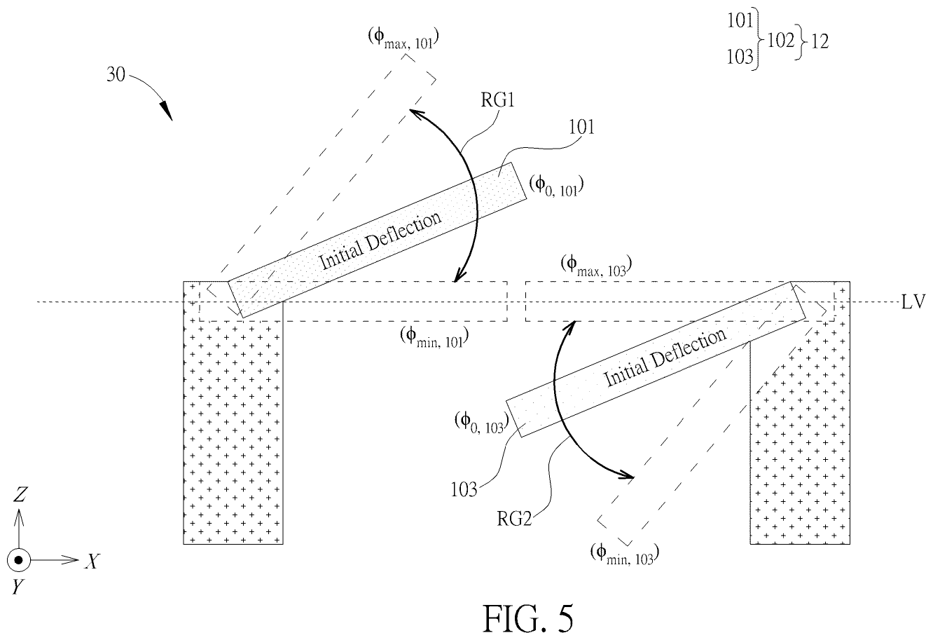

FIG. 5 illustrates a schematic diagram of Asymmetric initial deflection imposed on an APG device 30 according to an embodiment of the present invention. The APG device 30 is similar to the APG device 10, especially in static membrane structure. Difference of the APG device 30 (or the APG devices of the present invention) versus the APG device 10 is the driving scheme or the dynamic membrane movement. Some notations of the APG device 10 may be retained for the APG device 30 (or the APG devices of the present invention).

For example, the APG device 30 comprises a film structure 12 comprising a flap pair 102, wherein the flap pair 102 comprises the flaps 101 and 103 opposite to each other. The flap pair 102 operates at an ultrasonic frequency, such that the APG device 30 produces a plurality of air pulses at an ultrasonic pulse rate. The flap pair 102 performs a differential mode movement, to form virtual valve 112 or opening 112 at an opening frequency.

Different from the APG device 10, the flap pair 102 of the APG device 30 (or the APG devices of the present invention) possesses an initial deflection difference or exhibits an average displacement difference between the flap 101 and the flap 102, during an operation of the APG device.

In the embodiment shown in FIG. 5, the flap 101 is actuated to bend toward +Z direction (upward) and the flap 103 is actuated to bend toward −Z direction (downward). Different from the driving scheme 20, when the APG device 30 is imposed asymmetric initial deflection, the flap 101 initially deflects at an initial position φ_{0,101} and the flap 103 initially deflects at an initial position φ_{0,103}, when/for performing the differential mode movement. An initial deflection difference or an average displacement difference exits between the flap 101 and the flap 103, where both initial deflection difference and average displacement difference are larger than a thickness of the film structure.

Furthermore, the flap 101 swings over a range RG1 between positions φ_{min,101} and φ_{max,101}, expressed as RG1=[φ_{min,101}, φ_{max,101}], and the flap 103 swings over a range RG2 between positions φ_{min,103} and φ_{max,103}, expressed as RG2=[φ_{min,103}, φ_{max,103}]. Herein, φ_{⋅, x} may be considered as (angular) position of tip of flap x with respect to its anchor.

When the flap 101 swings to position φ_{min,101} and the flap 103 swings to position φ_{max,103}, the virtual valve 112 is considered as closed. In one embodiment, position φ_{min,101} and position φ_{max,103} may align with a certain horizontal level LV shown in FIG. 5. Swing range RG1 of the flap 101 is (substantially) above the level LV and swing range RG2 of the flap 103 is (substantially) below the level LV.

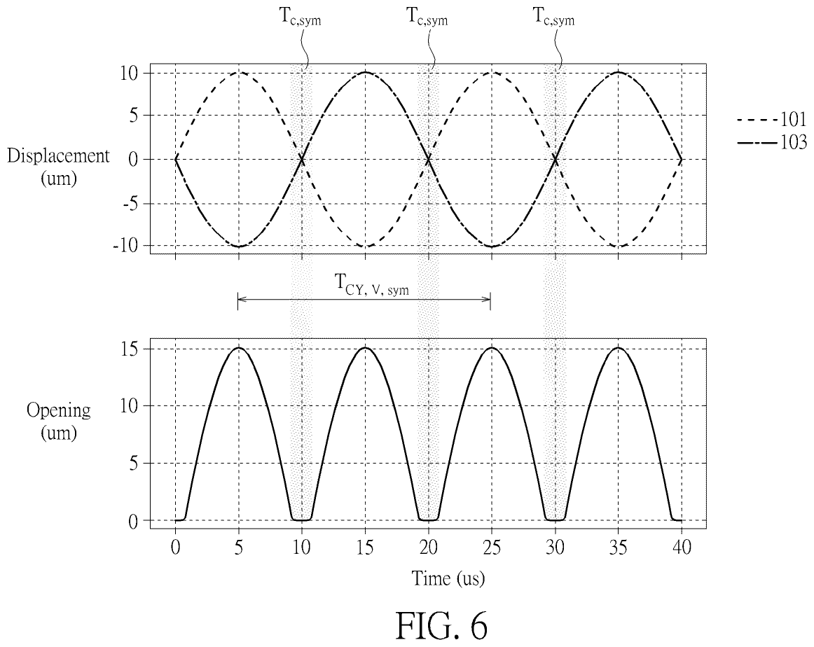

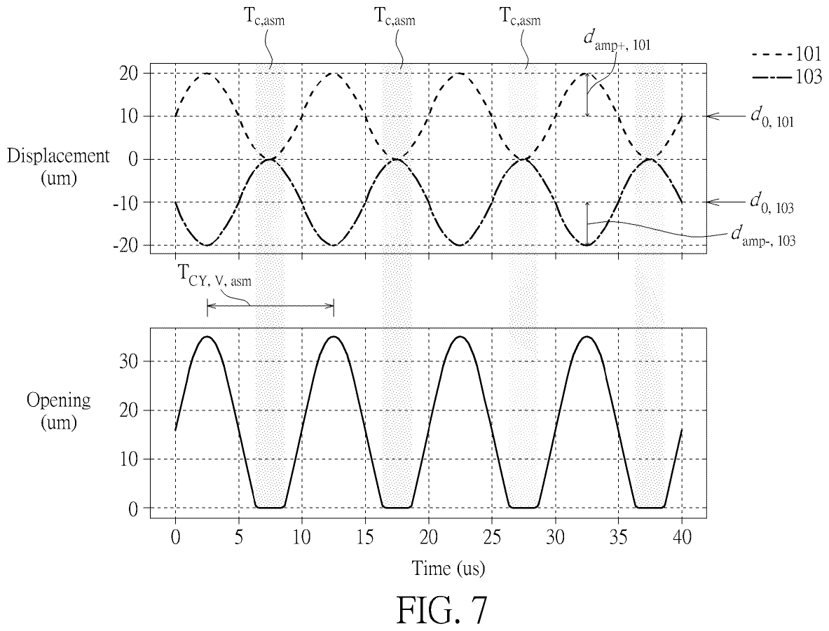

The transient displacements of flaps 101 and 103 and the resulting valve opening are shown in FIG. 6 (for symmetric deflection) and FIG. 7 (for Asymmetric deflection). In lower portion of FIG. 6 and FIG. 7, “opening being zero” means virtual valve 112 is closed.

For symmetric deflection, as shown in FIG. 6, the virtual valve 112 is closed during a period T_{c,sym} within transition period of one flap swinging downward and the other flap swinging upward. For Asymmetric deflection, on the other hand, the virtual valve 112 is closed during a period T_{c,asm} when both flaps 101 and 103 are around/at their reversal/turning/extreme points, as shown in FIG. 7.

An advantage of Asymmetric deflection, where the virtual valve 112 is closed at the reversal/turning/extreme points of the two flaps, is the virtual valve 112 is closed only ONCE during one valve driving cycle T_{CY,V}, which makes “F_{V}=F_{M} and fully utilizing resonance gain” feasible.

Specifically, within one valve driving cycle T_{CY,V,sym} for symmetric deflection, as shown in FIG. 6, the virtual valve 112 is closed twice: one is when the flap 101/103 swings downward/upward and the other is when the flap 101/103 swings upward/downward, which leads to F_{V}=½·F_{M}. On the other hand, for Asymmetric deflection of the present invention, since the virtual valve 112 is always closed around/at the reversal/turning/extreme points, the virtual valve 112 is closed only once within/during one valve driving cycle T_{CY,V,asm}, as shown in FIG. 7, which makes “F_{V}=F_{M} and fully utilizing resonance gain” feasible.

Specifically, since F_{V}=F_{M}, the valve driving frequency F_{V} and the pressure variant frequency F_{M} are the same, both F_{V} and F_{M} may be located close to or at the resonance frequency Fr, so that large resonance gain may benefit the enlargement of both ultrasonic pressure variation and valve opening. In other words, since F_{V}=F_{M}≈Fr, mechanical resonance gain can enlarge amplitude of both air pressure wave P(t) and virtual valve conductance G(t) shown in FIG. 4 of application Ser. No. 19/287,761. Moreover, since large resonance gain can be utilized, only small amplitude of electrical signal is sufficient for producing significant SPL. Therefore, the scheme within F_{V}=F_{M}≈Fr would not only significantly improve acoustic output performance such as SPL of the APG device, over U.S. Pat. No. 11,943,585, but also reduce power consumption for differential movement.

In the present invention, the valve driving frequency F_{V} or the pressure variant frequency F_{M} approaches the resonance frequency Fr, i.e., F_{V} or F_{M}≈Fr, means that the valve driving frequency F_{V} or the pressure variant frequency F_{M} is so close to the resonance frequency Fr such that a certain displacement gain brought from resonance (or equivalently, resonance gain) is gained/obtained. Take FIG. 4 as an example, suppose vertical axis of FIG. 4 is in linear scale, F_{V} or F_{M}≈Fr may refer that the valve driving frequency F_{V} or the pressure variant frequency F_{M} is so close to the resonance frequency Fr such that a certain displacement/resonance gain (e.g., 10 times) is obtained. If the desired resonance gain is achieved as 10 times, then F_{V} or F_{M} in a range of (95 KHz, 105 KHz) may be considered as F_{V} or F_{M}≈Fr. Practically/usually, resonance gain of 20-30 times (or above) is pursued, but not limited thereto.

In addition to resonance gain, the valve opening can be enlarged due to difference of initial deflection between the two flaps. For example, an maximum valve opening can be estimated as opening=|d_{0,101}+d_{amp+,101}−(d_{0,103}−d_{amp-,103})|(eq. 1), where d_{0,101}, d_{0,103} represent displacements corresponding to the initial position φ_{0,101}, φ_{0,103}, respectively, d_{amp+,101} represents amplitude of differential mode oscillating displacement with respect to initial displacement d_{0,101} toward +Z direction, and d_{amp-,103} represents amplitude of differential mode oscillating displacement with respect to initial displacement d_{0,103} toward −Z direction. Eq. 1 can be rewritten as opening=|d_{0,101}−d_{0,103}|+|d_{amp+,101}+d_{amp-,103}| (eq. 2). For symmetric deflection, |d_{0,101}−d_{0,103}|=0 and opening^{(sym)}=|d_{amp+,101}+d_{amp-,103}|. For Asymmetric deflection, |d_{0,101}−d_{0,103}|>0 and opening^{(asm)}=|d_{0,101}−d_{0,103}|+|d_{amp+,101}+d_{amp-,103}|>opening^{(sym)}. Therefore, the scheme of Asymmetric deflection and/or the scheme of virtual valve being closed at reversal points would significantly improve acoustic output performance such as SPL of the APG device, over U.s. Pat. No. 11,943,585.

The scheme of Asymmetric deflection can be realized by driving the two flaps 101 and 103 by two distinct valve driving signals which are biased at different bias level.

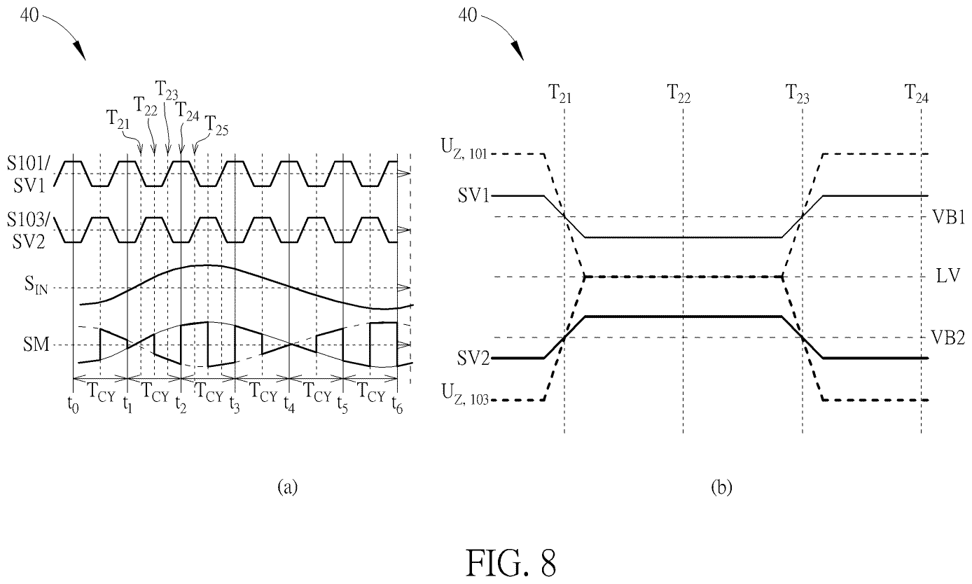

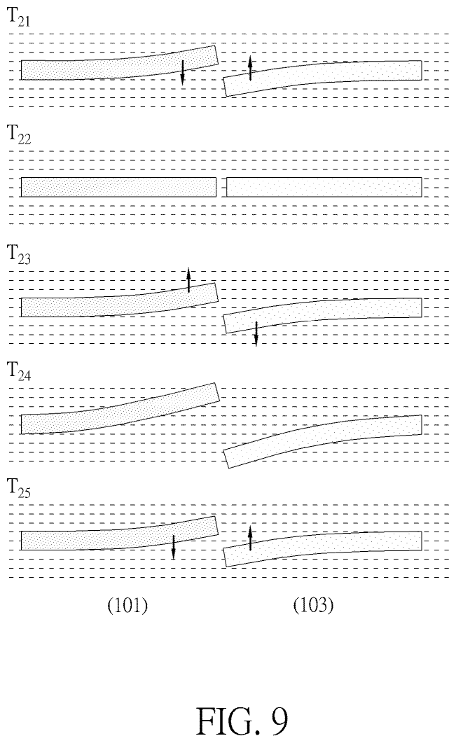

For example, FIG. 8(a) illustrates a driving scheme 30 showing waveforms of the signals S101/SV1, S103/SV2 and SM over multiple cycles T_{CY}, FIG. 8(b) illustrates waveforms of the signals S101/SV1, S103/SV2 and corresponding displacement U_{z,101}/U_{z,103}, and FIG. 9 illustrates snapshots of membrane/flap movement for the flaps 101 and 103 using the driving scheme 30.

As shown in FIG. 8, the valve driving signals S101/SV1 and S103/SV2 are biased at distinct levels (or bias voltages) VB1 and VB2. Hence, the initial deflection of the flap 101 and the initial deflection of the flap 103 are quite different. Moreover, when minimum of displacement (position of flap tip in Z axis) of flap 101 meets maximum of displacement (position of flap tip in Z axis) of flap 103, the valve may be closed only once within one valve driving cycle T_{CY,V}, which makes F_{V}=F_{M} feasible.

Also, at time T₂₂, the valve driving signal S101/SV1 has negative polarity with respect to the bias voltage VB1 and the valve driving signal S103/SV2 has positive polarity with respect to the bias voltage VB2, such that displacements U_{z,101} and U_{z,103} would achieve at level LV at the time T₂₂.

In other words, in FIG. 8 and FIG. 9, under the driving scheme 20, at times T₂₁ and T₂₃, corresponding swinging transition times of flaps 101 and 103, the virtual valve 112 is opened; at time T₂₂, corresponding reversal times of flaps 101 and 103, the virtual valve 112 is closed.

Wiring of the pressure (modulation) driving signal SM to the flaps 101 and 103 may be seen/referred in FIG. 1, which is not narrated herein for brevity.

In addition to asymmetric bias voltage, fabrication processes may be used to establish the Asymmetric initial deflection.

As fabrication processes may be performed on entire substrates, opposite flaps may have similar layer stacks and are expected to have similar initial deflections. It may be beneficial when generating the Asymmetric initial deflection not to cause a large difference in resonant frequency, mass, or stiffness, as the dynamic modes discussed above may become unbalanced. Several methods may be used to controllably define the asymmetric initial deflection.

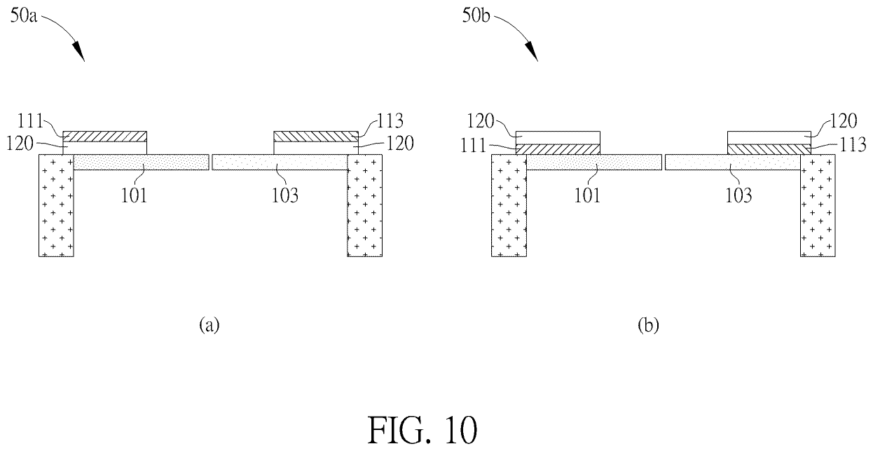

For example, the asymmetric initial deflection may be created by depositing layers with high internal mechanical stresses, and controlling the relative thickness of the high stress layers on the flap. In an embodiment (shown in FIG. 10), a controlled/first stress layer 111 (such as silicon oxide or nitride), may be deposited on/with one of the flaps 101 by various techniques such as chemical vapor deposition or sputtering, and patterned by masking or etching. Another layer with a different stress (or another/second stress layer) 113 may also be deposited and patterned on/with the other flap 103. In other words, a first internal stress of the first stress layer 111 is different from a second internal stress of the second stress layer 113. These stress layers 111 and 113 may be deposited over the piezoelectric layer 120 (as shown in FIG. 10(a)) or under the piezoelectric layer (FIG. 10(b)), where FIG. 10(a)/10(b) illustrates an APG device 50a/50b according to an embodiment of the present invention.

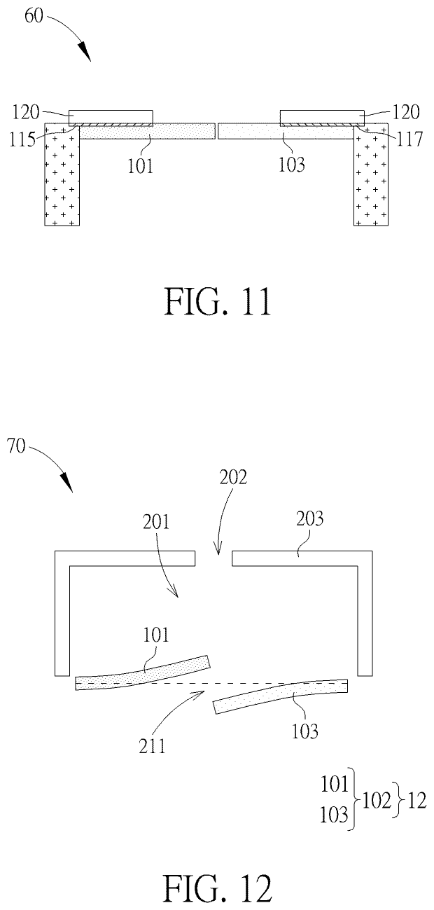

In another embodiment, localized heavy doping of silicon may be used to create regions of high stresses, as shown in FIG. 11, where an APG device 60 as an embodiment of the present invention is illustrated. Common dopants for silicon such as boron, phosphorus, or germanium are known to introduce significant stresses into the silicon lattice at high concentrations, such as around 10²⁰ atoms/cm³. These stresses may be compressive or tensile depending on the dopant. For example, at least one of the flaps 101 or 103 may have such heavy doping introduced into the silicon regions (doping region) 115 or 117 to obtain the desired stress.

In other words, a first doping characteristic of the first doping region 115 is different from a second doping characteristic of the second doping region 117. These doping characteristics may include, but are not limited to: (1) the dopant species or type (e.g., selecting distinct elements such as boron, phosphorus, or germanium to introduce specific lattice strains); (2) the doping concentration (e.g., utilizing different concentration levels, such as a heavy doping level of approximately 10²⁰ atoms/cm³ versus a lighter doping level of 10¹⁵ atoms/cm³; and (3) the doping profile (e.g., the specific depth, gradient, or spatial distribution of the dopants within the flap). By configuring the first doping region 115 and the second doping region 117 to possess distinct doping characteristics, the magnitude and type (compressive or tensile) of the internal stresses can be individually tailored to achieve the desired asymmetric initial deflection.

In addition, a resonance chamber may be incorporated into the APG device of the present invention, like U.S. Pat. No. 12,413,900. For example, FIG. 12 is a schematic diagram of an APG device 70 according to an embodiment of the present invention. In addition to the flap pair, the APG device 70 further comprises a covering structure 203. A resonant chamber 201 is formed between the covering structure 203 and the film structure 12. Outlet(s) 202 and chamber walls 203 may be designed with an acoustic resonant frequency close to the structural resonance of the flap. A resonance may be formed within the resonant chamber 201. The resonance may be a Helmholtz resonance or a standing wave resonance, which is not limited thereto.

The purpose of the resonant chamber is to closely couple the structural common mode of the flaps with the acoustic environment. The resonant chamber 201 is designed to have an acoustic resonant frequency (such as a Helmholtz or half-wavelength mode) close to the structural common mode frequency of the flap pair. When operating near this coupled resonant frequency, the acoustic mode generates a high acoustic impedance region at the flap, which creates a substantial opposing force, consequently reducing the displacement and velocity of the common mode.

The reduction in common mode displacement means that the unwanted ultrasonic acoustic energy generated on the opposite side of the flaps (e.g., region 211) is reduced. This is beneficial for saving wasted power and lowering the potential to cause annoyance or interfere with other ultrasonic device.

In addition, with smaller common-mode displacements, tooth-shaped flap edges as described in U.S. Pat. No. 12,317,034 are less likely to open at the teeth unintentionally or otherwise interfere with the valve operation due to nonlinearities. Smaller common-mode displacements make it less likely for tooth-shaped flap edges to unintentionally open or interfere with valve operation due to nonlinearities.

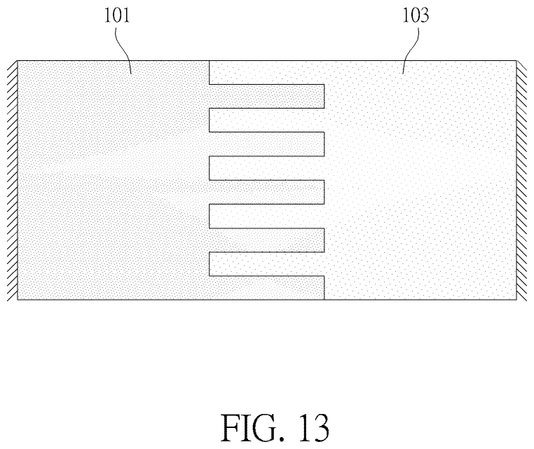

The flaps within the APG device of the present invention may comprise tooth edge. Flaps with tooth edge are illustrated in FIG. 13, detailed in No. 12,317,034, and not narrated herein for brevity.

Despite the reduced physical movement of the flaps, the pressure inside the acoustic resonance chamber 201 remains high, allowing for substantial power transmission from the structural flaps to the acoustic environment.

The differential mode movement, which is used for valve operation, involves the flaps moving in opposite directions. The differential mode movement may be mostly self-contained and balanced, since the differential flap movement causes the air surrounding the flaps to be mostly pushed back-and-forth locally between the vicinity of the opposing/opposite flaps 101 and 103. This results in minimal external acoustic interaction and low dissipation. Hence the quality factor of this mode may be high and it may not be significantly affected by acoustics further from the immediate vicinity of the flaps.

Collectively, the resonant chamber leverages the structural properties—the differential mode (for the valve) is decoupled (allowing high resonant gain), while the common mode (for ultrasound generation) is coupled. The coupling is used specifically to suppress unwanted common mode structural displacement, leading to reduced power consumption and noise.

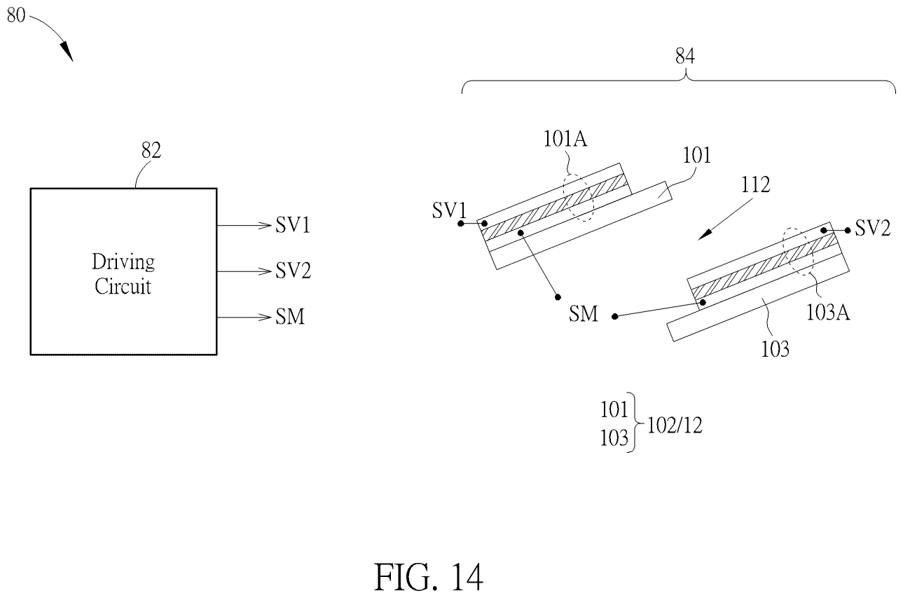

In addition, FIG. 14 illustrates a schematic diagram of an air-pulse generating (APG) system 80 according to an embodiment of the present invention. The APG system 80 comprises a driving circuit 82 and an APG device 84. The driving circuit 82 is configured to provide/generate driving signal to drive the APG device 84. The APG device 84 may be APG device mentioned above, especially the one possessing Asymmetric initial deflection mentioned in the present application.

In an embodiment, the APG device 82 may be the APG device 30 shown in FIG. 5 and the driving circuit 82 may generate the driving signals (e.g., SV1 and SV2) within the driving scheme 40 shown in FIG. 8, which is not limited thereto.

In an embodiment, the driving circuit 82 may comprise a pressure (modulation) driving signal generator, configured to generate the pressure (modulation) driving signal SM, and a valve (demodulation) driving signal generator, configured to generate the valve (demodulation) driving signals SV1 and SV2.

In an embodiment, the pressure (modulation) driving signal generator may be the one disclosed in U.S. Pat. No. 12,107,546, which is not limited thereto.

In an embodiment, the valve driving signal generator may comprise a raw valve driving signal generator, a capacitor and a resistor. The raw valve driving signal generator is configured to generate two/dual raw valve driving signals, where voltage levels of the two/dual raw valve driving signals swap with each other, and the two/dual raw valve driving signals are biased at the same voltage level. The two/dual raw valve driving signals (denoted as SV1′ and SV2′) biased at the same voltage level are suitable for the symmetric driving scheme (e.g., 20). To achieve Asymmetric driving scheme (e.g., 40), the capacitor and the resistor may be included.

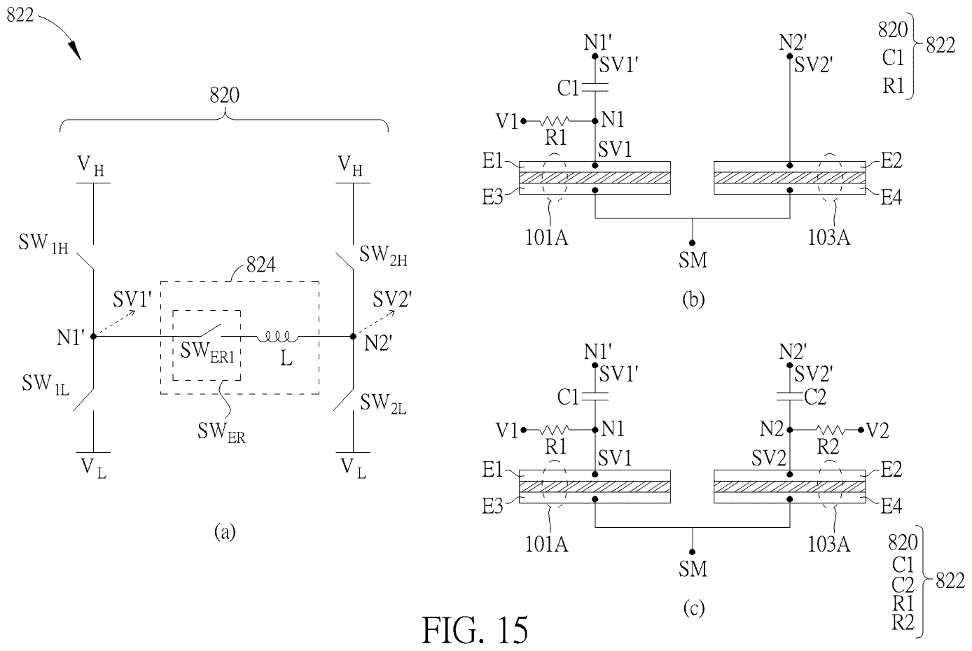

FIG. 15 illustrates a schematic diagram of a valve driving signal generator 822. Specifically, FIG. 15(a) illustrates a raw valve driving signal generator 820, FIG. 15(b) and FIG. 15(c) illustrates a connecting scheme between the raw valve driving signal generator 820 and the flaps 101 and 103, according to embodiments of the present invention. The valve driving signal generator 822 comprises the raw valve driving signal generator 820, the capacitor C1 and the resistor R1.

The raw valve driving signal generator 820 may be the driving circuit disclosed in U.S. Pat. No. 12,261,567, which is configured to generate the raw valve driving signals SV1′ and SV2′, where the signals SV1′ and SV2′ are biased at the same voltage level.

FIG. 15(b) illustrates a scheme where an additional voltage V1 is added to the raw valve driving signals SV1′, such that the valve driving signal SV1 received by an electrode E1 of the flap 101 has the bias voltage VB1 (as shown in driving scheme 40 in FIG. 8), where the bias voltage VB1 is related to the voltages V1, V_{H} and V_{L}. The capacitor C1 is coupled between (node N1′ of) the raw valve driving signal generator 820 and the electrode E1 of the flap 101. The resistor R1 is coupled to the capacitor C1 and the electrode E1 of the flap 101. The resistor R1 receives the voltage V1. The electrode E1 of the flap 101 may receive the raw valve driving signal SV1′ via the capacitor C1 and receive the voltage V1 via the resistor R1. The raw valve driving signal SV1′ and the voltage V1 are added/mixed at a node N1 as the valve driving signals SV1.

FIG. 15(c) illustrates a scheme where an additional voltage V2 is added to the raw valve driving signal SV2′, such that the valve driving signal SV2 received by an electrode E2 of the flap 103 has the bias voltage VB2 (as shown in driving scheme 40 in FIG. 8), where the bias voltage VB2 is related to the voltage V2, V_{H} and V_{L}. The capacitor C2 is coupled between (node N2′ of) the raw valve driving signal generator 820 and the electrode E2 of the flap 103. The resistor R2 is coupled to the capacitor C2 and the electrode E2 of the flap 103. The resistor R2 receives the voltage V2. The electrode E2 of the flap 103 may receive the raw valve driving signal SV2′ via the capacitor C2 and receive the voltage V2 via the resistor R2. The raw valve driving signal SV2′ and the voltage V2 are added/mixed at a node N2 as the valve driving signal SV2.

As shown in FIG. 15(a), the raw valve driving signal generator 820 comprises a resonance circuit 824, and the resonance circuit 824 comprises an inductor L. The inductor L and the capacitance within the actuators 101A and 103A would form an LC (Inductor-Capacitor) oscillator, and the LC oscillation would perform an energy recycling operation between capacitance of actuators (e.g., PZT (Lead Zirconate Titanate) actuators, where 101A and 103A may be PZT actuators), such that the voltage levels of the signals SV1′ and SV2′ swap with each other (see U.S. Pat. No. 12,261,567). In other words, the resonance circuit 824 and the flap pair 102 co-perform a resonance operation (e.g., LC oscillation), so as to generate the driving signals (e.g., SV1′ and SV2′) for the first flap 101 and the second flap 103.

Note that, the resonance circuit 824 is coupled between first node N1′ and second node N2′, where the raw valve driving signal generator 820 outputs the raw valve driving signal SV1′ via the node N1′ and outputs the raw valve driving signal SV2′ via the node N2′.

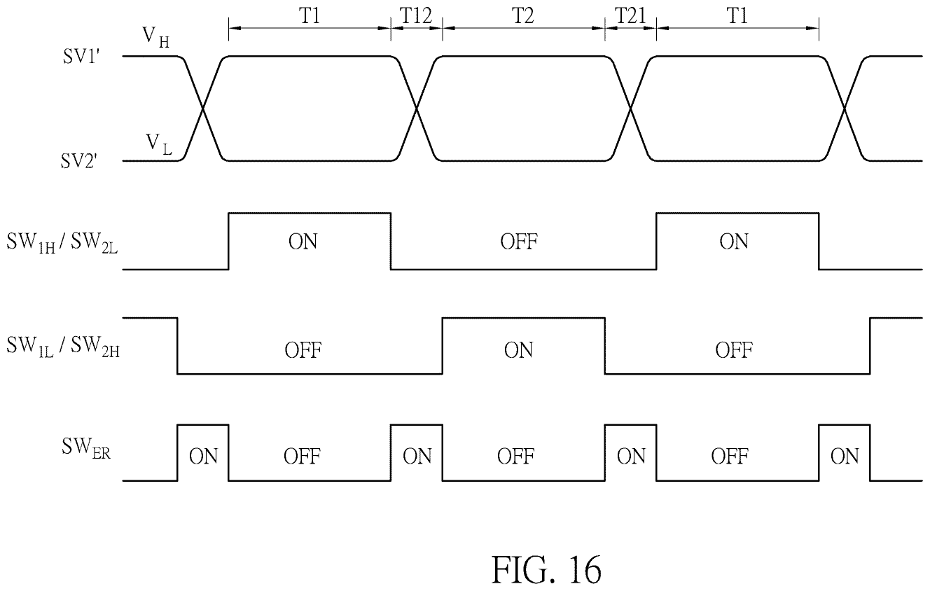

The raw valve driving signal generator 820 also comprises a switching unit SW_{ER}, coupled between the first node N1′ and the second node N2′. The switching unit SW_{ER} is conducted during a conduction period (e.g., T12 shown in FIG. 16, which will be detailed later).

In the embodiment shown in FIG. 15(a), the switching unit SW_{ER} comprises a/one switch SW_{ER1}, which is not limited thereto.

In the embodiment shown in FIG. 15(a), the raw valve driving signal generator 820 comprises switches SW_{1H}, SW_{1L}, SW_{2H} and SW_{2L}. The switches SW_{1H} and SW_{1L} are coupled to the first node N1′, and the third and fourth switches SW_{2H} and SW_{2L} are coupled to the second node N2′.

FIG. 16 illustrates a timing diagram of the raw valve driving signal generator 820. As shown in FIG. 16, during a first period T1 before the conduction period T12, the switches SW_{1H} and SW_{2L} are conducted and the switches SW_{1L} and SW_{2H} are cutoff. During a second period T2 after the conduction period T12, the switches SW_{1H} and SW_{2L} are cutoff and the switches SW_{1L} and SW_{2H} are conducted. During the first period T1 or during the second period T2, the switching unit SW_{ER} is cutoff. During the conduction period, the switches SW_{1H}, SW_{1L}, SW_{2H} and SW_{2L} are cutoff.

During the conduction period (e.g., T12), energy recycling operation is performed. After the conduction period (e.g., T12) or the energy recycling operation, voltage levels of the raw valve driving signal SV1′ and the raw valve driving signal SV2′ swap.

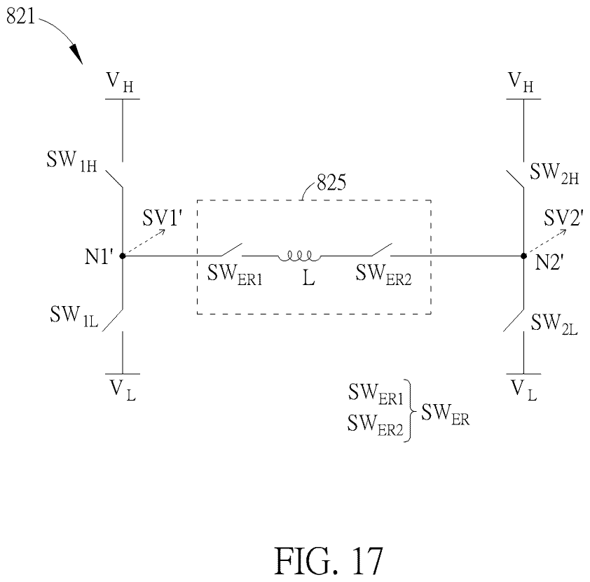

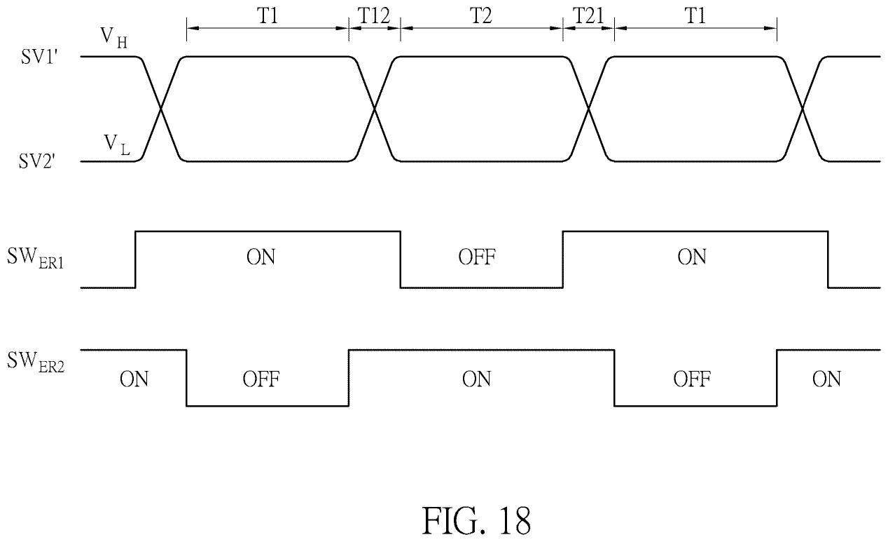

FIG. 17 illustrates a raw valve driving signal generator 821 according to an embodiment of the present invention. The raw valve driving signal generator 821 comprises a resonance circuit 825. The resonance circuit 825 comprises a switching unit SW_{ER}. The switching unit SW_{ER} comprises (switches) SW_{ER1} and SW_{ER2}, coupled between the first node N1′ and the second node N2′. Timing diagram of the raw valve driving signal generator 821 may be referred to FIG. 18.

Details of the raw valve driving signal generator 820/821 may be referred to U.S. Pat. No. 12,261,567, which is not narrated herein for brevity.

In summary, the present invention provides an APG system and driving circuit thereof with Asymmetric initial deflection. By imposing the asymmetric initial deflection, the device of the present invention enables the synchronization of valve driving and pressure modulation frequencies approaching the structural resonance (F_{V}=F_{M}≈Fr). This alignment fully exploits the mechanical resonance to maximize displacement gain and valve conductance, significantly enhancing SPL and reducing power consumption. The asymmetric initial deflection scheme also renders the device immune from false demodulation.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. An air-pulse generating system, comprising:
a driving circuit and an air-pulse generating device comprising a film structure;
wherein the film structure comprises a flap pair, and the flap pair comprises a first flap and a second flap opposite to each other;
wherein the flap pair is driven by the driving circuit to operate at an ultrasonic frequency, such that the air-pulse generating device produces a plurality of air pulses at an ultrasonic pulse rate;
wherein the flap pair possesses an initial deflection difference or exhibits an average displacement difference between the first flap and the second flap.

2. The air-pulse generating system of claim 1,
wherein the initial deflection difference or the average displacement difference is larger than a thickness of the film structure.

3. The air-pulse generating system of claim 1,
wherein the flap pair is driven by the driving circuit to perform a differential mode movement, to form a virtual valve or an opening at an opening frequency;
wherein the flap pair is driven by the driving circuit according to a valve driving frequency to perform the differential mode movement;
wherein the valve driving frequency is the ultrasonic pulse rate.

4. The air-pulse generating system of claim 3,
wherein the flap pair is driven by the driving circuit to perform a common mode movement, to form an ultrasonic air pressure variation;
wherein a pressure variant frequency corresponding to the common mode movement and a valve driving frequency corresponding to the differential mode movement are the same.

5. The air-pulse generating system of claim 4,
wherein both the pressure variant frequency and the valve driving frequency approach a resonance frequency of the flap pair.

6. The air-pulse generating system of claim 1,
wherein the flap pair is driven by the driving circuit to form a virtual valve;
wherein the virtual valve is closed during a time corresponding to a first reversal of a first flap movement of the first flap and a second reversal of a second flap movement of the second flap.

7. The air-pulse generating system of claim 1,
wherein the first flap is driven by a first valve driving signal with a first bias voltage;
wherein the first valve driving signal comprises a first raw valve driving signal and a first voltage corresponding to the first bias voltage.

8. The air-pulse generating system of claim 7, wherein the driving circuit comprises:
a raw valve driving signal generator, configured to produce the first raw valve driving signal;
a first capacitor, comprising a first end coupled to the raw valve driving signal generator and a second end coupled to a first electrode of the first flap.

9. The air-pulse generating system of claim 8, wherein the driving circuit comprises:
a first resistor, coupled to the first electrode of the first flap;
wherein a first node of the first electrode receives the first raw valve driving signal via the first capacitor and receives the first voltage via the first resistor.

10. The air-pulse generating system of claim 7,
wherein the second flap is driven by a second valve driving signal with a second bias voltage;
wherein the second valve driving signal comprises a second raw valve driving signal and a second voltage corresponding to the second bias voltage.

11. The air-pulse generating system of claim 10, wherein the driving circuit comprises:
a raw valve driving signal generator, configured to produce the first raw valve driving signal and the second raw valve driving signal;
a first capacitor, coupled between the raw valve driving signal generator and a first electrode of the first flap; and
a second capacitor, coupled between the raw valve driving signal generator and a second electrode of the second flap.

12. The air-pulse generating system of claim 11, wherein the driving circuit comprises:
a first resistor coupled to the first electrode and a second resistor coupled to the second electrode;
wherein a first node of the first electrode receives the first raw valve driving signal via the first capacitor and receives the first voltage via the first resistor;
wherein a second node of the second electrode receives the second raw valve driving signal via the second capacitor and receives the second voltage via the second resistor.

13. The air-pulse generating system of claim 10,
wherein the first valve driving signal has a first polarity with respect to the first bias voltage and the second valve driving signal has a second polarity with respect to the second bias voltage;
wherein the first polarity and the second polarity are opposite to each other.

14. The air-pulse generating system of claim 7,
wherein the first flap and the second flap are driven by a pressure driving signal, to perform a common mode movement to form a pressure variation;
wherein the driving circuit produces the pressure driving signal;
wherein a valve driving frequency corresponding to the first valve driving signal and a pressure variant frequency corresponding to the pressure driving signal are the same.

15. An air-pulse generating system, comprising:
a driving circuit and an air-pulse generating device comprising a film structure;
wherein the film structure comprises a flap pair, and the flap pair comprises a first flap and a second flap opposite to each other;
wherein the flap pair is driven by the driving circuit to operate at an ultrasonic frequency, such that the air-pulse generating device produces a plurality of air pulses at an ultrasonic pulse rate;
wherein the flap pair is driven by the driving circuit to perform a differential mode movement to form a virtual valve;
wherein the virtual valve is closed during a time corresponding to a first reversal of a first flap movement of the first flap and a second reversal of a second flap movement of the second flap.

16. An air-pulse generating system, comprising:
a driving circuit and an air-pulse generating device comprising a film structure;
wherein the film structure comprises a flap pair, and the flap pair comprises a first flap and a second flap opposite to each other;
wherein the flap pair is driven by the driving circuit to operate at an ultrasonic frequency, such that the air-pulse generating device produces a plurality of air pulses at an ultrasonic pulse rate;
wherein the flap pair is driven by the driving circuit to perform a differential mode movement to form a virtual valve;
wherein the flap pair is driven by the driving circuit to perform a common mode movement, to form an ultrasonic pressure variation;
wherein a pressure variant frequency corresponding to the common mode movement and a valve driving frequency corresponding to the differential mode movement are the same.

17. A driving circuit, comprising:
a valve driving signal generator, configured to generate a first valve driving signal and a second valve driving signal;
wherein the driving circuit is configured to drive an air-pulse generating device, the air-pulse generating device comprises a flap pair, and the flap pair comprises a first flap and a second flap;
wherein the flap pair is driven by the valve driving signal generator to possess an initial deflection difference or exhibits an average displacement difference between the first flap and the second flap.

18. The driving circuit of claim 17,
wherein the first flap is driven by a first valve driving signal with a first bias voltage;
wherein the first valve driving signal comprises a first raw valve driving signal and a first voltage corresponding to the first bias voltage;
wherein the valve driving signal generator comprises a raw valve driving signal generator;
wherein the raw valve driving signal generator generates the first raw valve driving signal.

19. The driving circuit of claim 18, wherein the valve driving signal generator comprises:
a first capacitor, coupled between the raw valve driving signal generator and the first flap.

20. The driving circuit of claim 19, wherein the valve driving signal generator comprises:
a first resistor, coupled to a first electrode of the first flap;
wherein the first electrode receives the first raw valve driving signal via the first capacitor and receives the first voltage via the first resistor.

21. The driving circuit of claim 18,
wherein the second flap is driven by a second valve driving signal with a second bias voltage;
wherein the second valve driving signal comprises a second raw valve driving signal and a second voltage corresponding to the second bias voltage;
wherein the raw valve driving signal generator generates the first raw valve driving signal and the second raw valve driving signal.

22. The driving circuit of claim 21, wherein the valve driving signal generator comprises:
a first capacitor, coupled between the raw valve driving signal generator and the first flap;
a second capacitor, coupled between the raw valve driving signal generator and the second flap;
a first resistor coupled to a first electrode of the first flap; and
a second resistor coupled to a second electrode of the second flap;
wherein the first electrode receives the first raw valve driving signal via the first capacitor and receives the first voltage via the first resistor;
wherein the second electrode receives the second raw valve driving signal via the second capacitor and receives the second voltage via the second resistor.

23. The driving circuit of claim 18, wherein the raw valve driving signal generator comprises:
a resonance circuit;
wherein the resonance circuit and the flap pair co-perform a resonance operation, so as to generate driving signals for the first flap and the second flap.

24. The driving circuit of claim 23, wherein the resonance circuit comprises:
an inductor, coupled between a first node coupled to the first flap and the second node coupled to the second flap.

25. The driving circuit of claim 24, wherein the raw valve driving signal generator comprises:
a switching unit, coupled between the first node and the second node;
wherein the switching unit is conducted during a conduction period.

26. The driving circuit of claim 25,
wherein the raw valve driving signal generator produces the first raw valve driving signal and a second raw valve driving signal;
wherein a first voltage level of the first raw valve driving signal and a second voltage level of the second raw valve driving signal swap after the conduction period.

27. The driving circuit of claim 25, wherein the raw valve driving signal generator comprises:
a first switch, a second switch, a third switch and a fourth switch;
wherein the first and second switches are coupled to the first node, and the third and fourth switches are coupled to the second node.

28. The driving circuit of claim 27,
wherein during a first period before the conduction period, the first and the fourth switches are conducted and the second and the third switches are cutoff;
wherein during a second period after the conduction period, the first and the fourth switches are cutoff and the second and the third switches are conducted;
wherein during the first period or during the second period, the switching unit is cutoff;
wherein during the conduction period, the first switch, the second switch, the third switch and the fourth switch are cutoff.

29. The driving circuit of claim 17,
wherein the flap pair is driven by the first valve driving signal and the second valve driving signal to perform a differential mode movement to form a virtual valve;
wherein the virtual valve is closed during a time corresponding to a first reversal of a first flap movement of the first flap and a second reversal of a second flap movement of the second flap.

30. The driving circuit of claim 17,
wherein the flap pair is driven by the first valve driving signal and the second valve driving signal to perform a differential mode movement to form a virtual valve;
wherein the flap pair is driven by a pressure driving signal to perform a common mode movement, to form an ultrasonic pressure variation;
wherein a pressure variant frequency corresponding to the common mode movement and a valve driving frequency corresponding to the differential mode movement are the same.
